(19) United States
(12) Patent Application Publication
(10) Pub. No.: US 2017/0180540 A1
(43) Pub. Date: Jun. 22, 2017

(54) Emergency Mode Mobile Call Agent

(71) Applicant: AT&T Intellectual Property I, LP, Atlanta, GA (US)

(72) Inventors: Venson M. Shaw, Kirkland, WA (US); Jin He, Fremont, CA (US)

(21) Appl. No.: 14/972,357

(22) Filed: Dec. 17, 2015

(51) Int. Cl. H04M 1/725; H04M 1/00; H04W 76/00

(52) U.S. Cl. CPC H04M 1/72536; H04W 76/007; H04M 1/006; H04M 1/72552

(57) ABSTRACT

An emergency mobile call agent includes a mobile originating call agent and a mobile terminating call agent. The mobile originating call agent responds to receiving an emergency notification and the emergency being above an emergency threshold condition, by notifying a contact list associated with a user that the user is impacted by the emergency. The mobile originating call agent may notify the contact list if the emergency is at or above a threshold emergency level set by the user. The mobile terminating call agent controls cellular traffic by evaluating one or more aspects of radio access network (RAN) loading and diverting incoming traffic to a user impacted by the emergency to another form of communication if RAN loading is too high for the traffic.

### BACKGROUND

### Field of the Disclosure

This application relates to management of cellular networks and more particularly to managing cellular networks in emergency situations.

### Description of the Related Art

During natural disasters and/or other emergency scenarios (e.g., earthquake, hurricane, tornado, flood, tsunami, terrorist attack, etc.) managing the cellular network is extremely critical. During these emergency scenarios, the cellular communication demand surges to many times more than normal. The cellular network is typically designed and capacity managed with a “normal call model” in mind. That is, the network capacity is designed to handle the peaks expected under normal, not emergency, operating conditions. Accordingly, design and capacity management of the cellular network to meet the excessive demands during emergency situations is extremely difficult and challenging. While today's long term evolution (LTE) network delivers superior speed improvements over 3G networks, the LTE network still becomes overloaded due to excessive demand and insufficient availability of resources during emergency situations. As a result, today's LTE network may not be able to support all the demands for Mobile Originated Short Message Service (SMS), Mobile Terminated SMS, circuit switched (CS) voice, and/or packet switched PS data during emergency situations.

FIG. 1 illustrates how an LTE network 100 may be utilized during emergency conditions. During an emergency, the user 101 may employ user equipment 102 to try to contact family members 103, friends 105, and/or update status on a social network 107, or friends and family may try to contact the user 101. However during the emergency, the over the air interface 111 between the user 101 and the access node (eNodeB) 109 is vulnerable to congestion because the heavy demands being placed on the network can exceed network capacity making it very difficult for a variety of communication services to be available to UE equipment in the emergency area.

### SUMMARY OF EMBODIMENTS

Accordingly, in an embodiment a method includes, responsive to receiving a notification of an emergency, evaluating one or more aspects of radio access network (RAN) loading and diverting an incoming voice call for a user to another form of communication responsive to the one or more aspects of RAN loading being above a threshold. The method may further include, responsive to receiving the notification and the emergency being above an emergency threshold condition, taking action to cause one or more stored contacts to be contacted that the user is impacted by the emergency.

In another embodiment, an emergency mode call agent system includes at least one processor and a memory in communication with the processor, the memory comprising computer-executable instructions. When executed by the at least one processor, the instructions cause the at least one processor to perform mobile originating emergency call operations including, responsive to receiving an emergency notification, taking action to cause one or more registered contacts to be contacted that a user is impacted by the emergency if the emergency corresponds to an emergency triggering condition set by the user.

In another embodiment an emergency mode call agent system includes one or more processors and a memory in communication with the one or more processors. The memory includes computer-executable instructions that, when executed by the one or more processors, cause the one or more processors to perform mobile terminating emergency call operations responsive to receiving a notification of an emergency. The mobile terminating emergency call operations include evaluating one or more aspects of radio access network (RAN) loading and diverting incoming calls from voice format to another communication format responsive to the one or more aspects of the loading being above a threshold.

### BRIEF DESCRIPTION OF THE DRAWINGS

The present invention may be better understood, and its numerous objects, features, and advantages made apparent to those skilled in the art by referencing the accompanying drawings.

FIG. 1 illustrates use of a prior art network in emergency situations.

FIG. 2A illustrates an embodiment including a Mobile Originating Call Agent (MO-CA) to manage emergency loading on the network.

FIG. 2B illustrates an embodiment including a Mobile Terminating Call Agent (MT-CA) to manage emergency loading on the network.

FIG. 3 illustrates another view of the network including the logical service entities MO-CA and the MT-CA as a network node.

FIG. 4 illustrates a high level flow diagram of operation of the MOCA.

FIG. 5 illustrates a high level flow diagram of operation of the MTCA.

FIG. 6 illustrates a processor system that may be utilized in an embodiment for the MOCA and/or the MTCA.

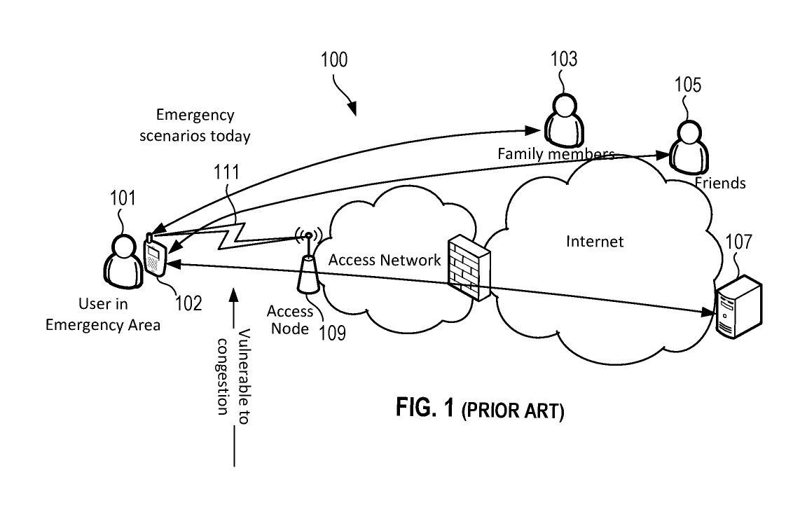

The use of the same reference symbols in different drawings indicates similar or identical items.

### DETAILED DESCRIPTION

Over the air interfaces are much more likely to be congested during high call volume cases. The capacity numbers for the data service and SMS of a 4G eNodeB (base station) can be modeled as 10 times those of a 3G NodeB. If not managed properly, various services offered in the network can cause bottlenecks in different network elements, In UMTS (3G), since it is a best-effort service, there is no limit on Mobile Originating (MO) SMS on a Radio Network Controller (RNC), which normally serves several NodeBs or on a NodeB (the 3G basestation). In 3G networks, the MO-SMS capacity can be 10,000-100,000 SMS services per second. In the real world, the Mobile Originating (MO) SMS Service capacity is rarely reached and SMS congestion has rarely been observed. Mobile Terminating (MT) SMS Service Capacity is more limited in 3G. MT-SMS is shared with CS (yoke service) on a paging channel. In a 3G network, a commonly used capacity limit is 250 SMS paging plus voice paging per RNC per second. In 3G networks, there are potential bottlenecks on the SMS center (SMS-C). MSC, as well. MO/MT CS (voice) Service Capacity per NodeB is several hundred. In 3G, the MO/MT PS (data) Service Capacity is a few hundred Megabits per second in total, say 500 Mbps. That can normally translate to thousands of simultaneous active users. In addition, the “Dwelling time” for a Data. Service Session is also a key. For example, to send a SMS or receive a SMS takes less than a second use of the network. A data service for web browsing, email checking, document downloading lasts from a few seconds to a few tens of seconds. Data services like packet switched voice calls, and video and audio streaming normally take a few minutes or longer. A voice service in UNITS may last for 10-20 minutes on average.

The capacity numbers for the data service and SMS of a 4G eNodeB (base station) can be modeled as 10 times those of a 3G NodeB. Note that today's LTE 4G does not support voice service. A user who needs to make a voice call has to fall back to 3G. 4G does support data service and SMS service.

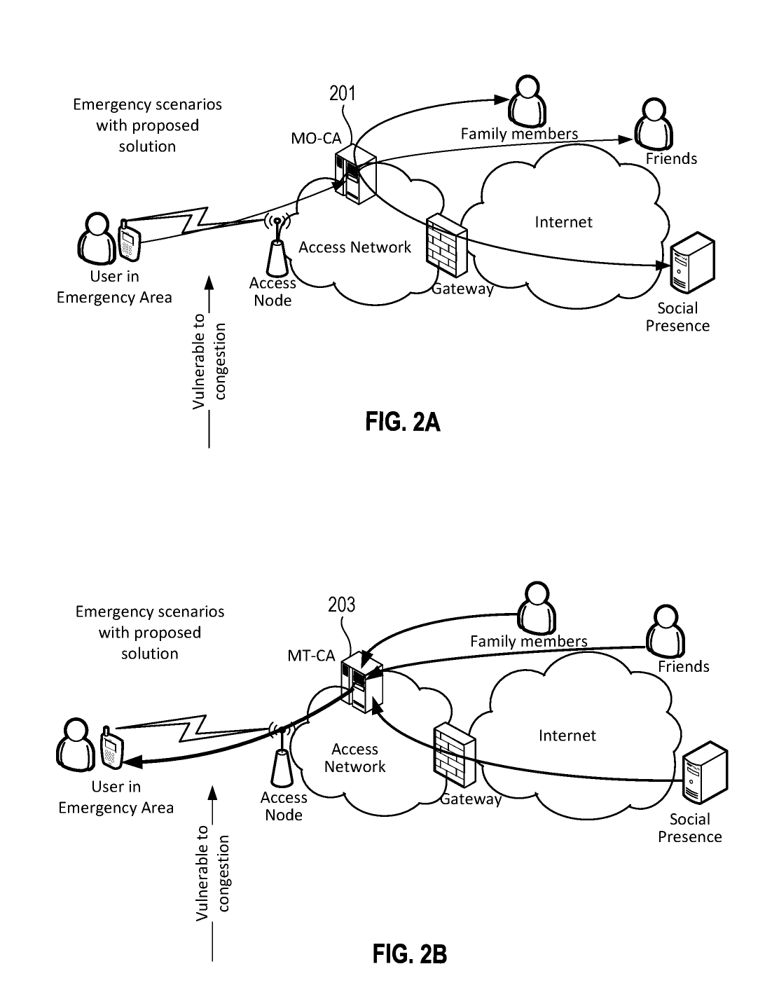

In order to better manage the network in an emergency as shown in FIGS. 2A and 2B, the telecommunications emergency service includes a mobile emergency service call agent that includes two logical service entities, Mobile Originating Call Agent (MO-CA) service 201 and the Mobile Terminating Call Agent (MT-CA) service 203. The MO-CA entity 201 contains (or has access to) a user contact information database. The user contact information database allows the customers to pre-configure a profile on the agent with data and configuration settings.

The profile may include a list of family members with their contact information. Additionally, the contact information may include a list of friends with their contact information, business contacts' contact information, etc. The contacts can be grouped by family, friends, business, or other groupings that may be set by the user. The contact information for each contact may contain various ways of communicating with each contact including email, text, voice, voice mail, mail, or other forms of communicating. In addition, the email address, telephone number, name of contact and/or other pertinent information is included in the contact information. In addition, the contact information may include priorities for each of the various ways of communicating. For example, the priority may try text first, then voice, and then email if a particular contact has multiple forms of communication identified in the profile database and one form of communication fails. A user may configure their profile from their user equipment or as part of account services made available to the user through any internet connection.

The profile may further include action triggering conditions. The action triggering conditions specify under what condition the agent shall take actions without order from the user to contact registered contacts and report that this user is impacted by a particular emergency. The condition may be based on the emergency level set by the Federal Emergency Management Agency (FEMA) or other federal or state governmental organization. There may be multiple emergency level conditions, e.g., yellow, orange, and red, where red is the most serious. The profile may specify the condition for the agent contacting one group in the profile (e.g. family) if the emergency level is red, contacting friends if the emergency level is orange, and automatically contacting nobody if the emergency level is yellow. In some circumstances, the user may not set up a profile and fail to register family, friends, or business contacts as part of the profile. In an embodiment, a default list of contacts may be based on, e.g., a “favorites” list found in a user's user equipment and the default automatic notification only occurs at the most severe emergency level. The user may use favorites lists found on user equipment as the basis for the contact information while setting up the profile.

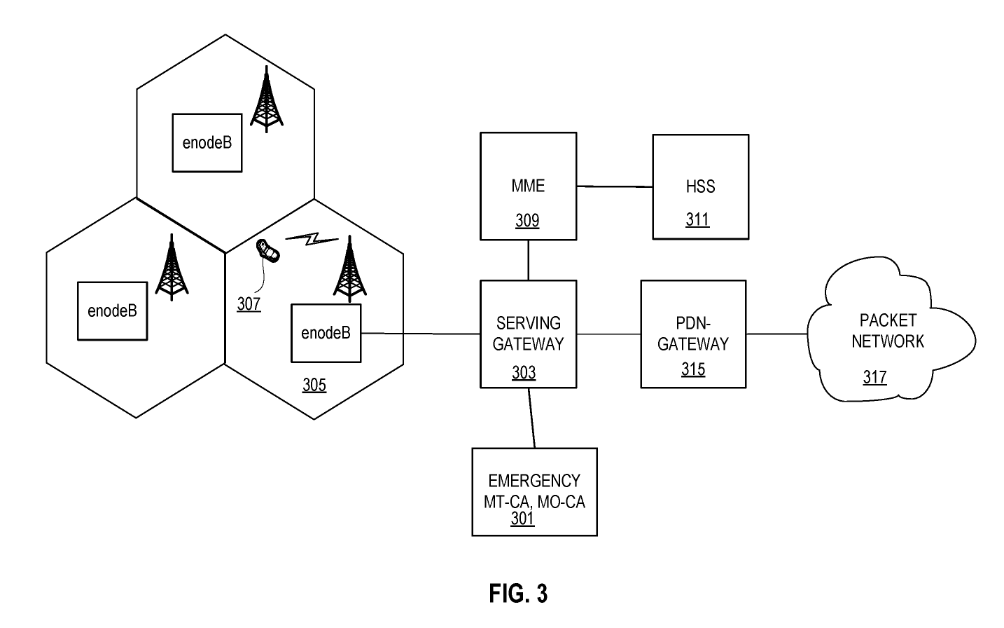

The fact that a user is being impacted by a particular emergency may be based on the presence of user equipment associated with the user in an impacted area. For example, referring to FIG. 3, another view of an LTE network is shown with the MO-CA and MTCA shown as combined in network node 301, coupled to the serving gateway 303. If cell 305 is impacted by the emergency and user equipment 307 is known to be located in cell 305, the Mobile Originated Call Agent performs the pre-configured actions on behalf of the user if the pre-configured actions triggering conditions are met. For example, if an emergency of the predetermined level occurs, the MO-CA will text all the family members of the user in the database. Note that while MTCA and MOCA are shown as a separate network node 301, the functionality, or a portion thereof, may be included as part of Mobility Management Entity 309, Home Subscriber Server (HSS) 311, or elsewhere in the network. For example, the profile database may be included in the HSS. The Packet Data Network (PDN) Gateway 315 provides access to the packet network 317 that may be used, e.g., to update a user's social network status.

During the emergency, MO-CA service may also allow the user to use SMS or allow light data sessions to manually order the agent to contact those pre-defined contacts or contact groups to deliver certain messages, e.g., “I am ok”, where I am, who I am with, and/or change their social network status line. For example, if the profile does not allow the MO-CA to contact automatically, the MO-CA may still allow the user to control when the emergency message goes out using the predefined contacts or contact groups using the SMS or light data sessions. The light data sessions may be limited in time and the bandwidth allocated limited thereby allowing only limited data to be exchanged with the user during emergency situations.

The Mobile Terminating Call Agent (MTCA) entity 203/401 monitors the load of the radio access network (RAN) very closely, e.g., the utilization of each resource and service, the difference between the monitored utilization of the resources and services with the capacity limits of the resource and service. For example, the MTCA 203/401 may track total utilization of the cell, the number of Mobile Originated SMS messages, Mobile Terminated SMS messages, circuit switched (CS) voice calls, or packet switched data sessions. All Mobile Terminated voice calls or Mobile Terminated SMS messages toward users under coverage of the emergency area go through the MTCA 203/401 first.

If MTCA 203/401 determines the radio access network (RAN) is loaded beyond a threshold, meaning that the capacity is being fully utilized or excess capacity is being reserved for other purposes, the MTCA will try to defer the calls to a bulletin or users' social network status where users will post their status. For example, MTCA can play a voice prompt stating that “John Doe just has posted his status on Facebook 20 minutes ago. Please try to use Facebook to check his status, instead of direct voice call unless this call is urgent.” Another function the MTCA can perform is that in extreme cases where the voice service in RAN is overloaded and a particular voice call is urgent, MTCA may choose to convert the voice call to SMS and deliver to converted voice call to the user.

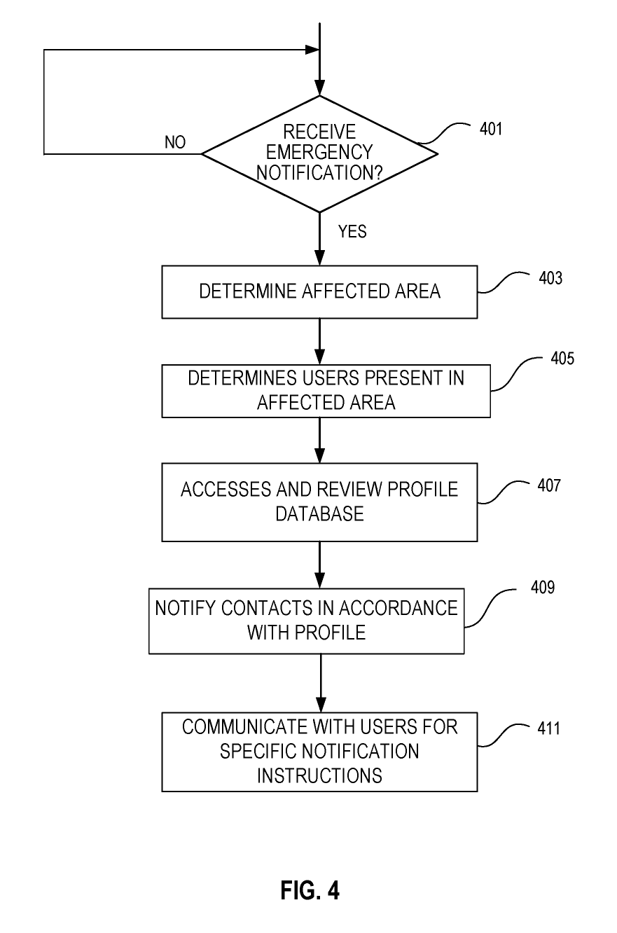

FIG. 4 illustrates a high level flow chart of operation of the MO-CA. In 401 the MO-CA waits to receive a notification of an emergency situation for one or more cells from, e.g., FEMA. When the emergency notification is received, the MO-CA determines in 403 the affected area, e.g., what cell(s) are impacted in the geographic area indicated by the alert, e.g., by latitude and longitude and determines in 405 the users that are present in the affected areas. The MO-CA may query the eNodeB and/or the MME or other network nodes to determine what users are present in particular cells. The 407 MO-CA accesses and reviews the user contact information in the profile database for users who are present within the affected cell or cells. In 409 the MO-CA notifies the users' contacts in accordance with user profiles by text, voice, etc. In addition, the MO-CA may communicate in 411with users in light data sessions or through SMS and make notifications as instructed by the users as described above.

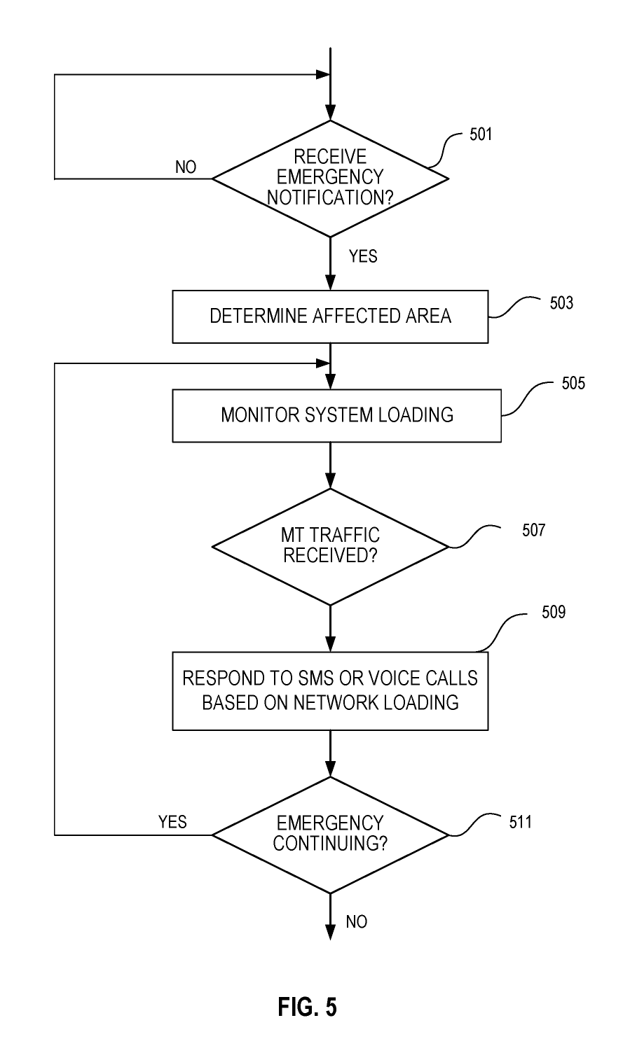

FIG. 5 illustrates a high level flow chart of operation of the MT-CA. In 501 the MT-CA waits for a notification of an emergency situation for one or more cells. When the emergency notification is received, the MT-CA the determines the affected area in 503 and in 505 MT-TA monitors system loading in 503. That monitoring may include overall cell utilization as well as utilization by type of service to allow the MT-CA to limit or modify service where appropriate. In 507 MT-CA waits for mobile terminated traffic to be received. When mobile terminated traffic is received destined for the cell impacted by the emergency situation, in 509 the MT-CA responds to SMS or voice calls to a user in the affected area based on network loading. For example, SMS messages may be allowed through but voice calls directed to a prerecorded message inviting the caller to check social network status of the user. Alternatively, based on network loading, in 509 the MT-CA may convert a voice call or voice message to an SMS message. If the emergency situations continues in 511, the MT-CA continues to monitor system loading in 503 and wait for MT-CA in 507. Note that rather than operating sequentially, the monitoring in 505 and waiting in 507 should be thought of as occurring concurrently.

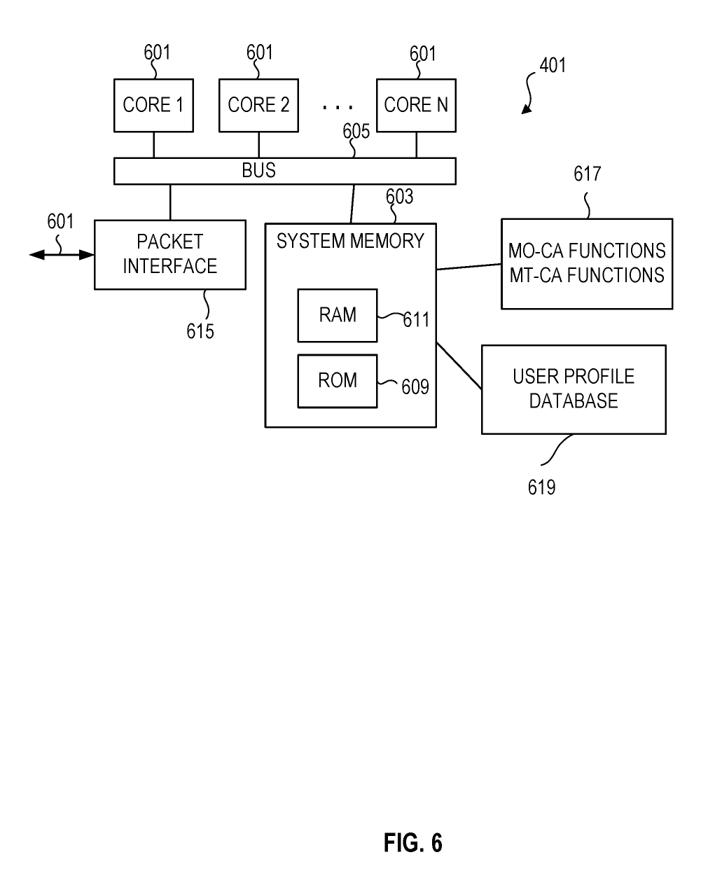

FIG. 6 illustrates a high level simplified block diagram of a processor system that may be utilized to implement the logical service entities MO-CA 201/401 and MT-CA 203/401. In embodiments, the MT-CA and MO-CA functions may be realized as standalone applications executing on a server or a group of servers and deployment configurations can vary depending on the actual network design. In other embodiments, the functionality provided by MT-CA and MO-CA may be incorporated in other network nodes and be part of another server. The following description in conjunction with FIG. 6, is intended to provide a brief, general description of a suitable processing system, which can be used with one or more embodiments described herein. With reference again to FIG. 6, the processor system includes one or more processing cores 601, a system memory 603 and a system bus 605. The system bus may be used to couple various system components including, but not limited to, the system memory 603 and the cores 601. The functionality described herein for the MT-CA and MO-CA and FIGS. 4 and 5 may be implemented in software modules 617 stored in system memory 603 and executed by one or more of the cores. The software or program modules are computer-executable instructions that operate on one or more of the cores 601 for performing the functions described herein. Generally, program modules include routines, programs, components, data structures, etc., that perform particular tasks. The system bus 605 can be any of several types of bus structures that can further interconnect to a memory bus (with or without a memory controller), a peripheral bus, and a local bus using any of a variety of commercially available bus architectures. The system memory 603 may include nonvolatile memory 609 and volatile memory 611. A basic input/output system (BIOS) can be stored in the non-volatile memory such as ROM, erasable programmable read only memory (EPROM), EEPROM, which BIOS contains the basic routines that help to transfer information between elements within the processor, such as during startup. As used herein, terms such as “memory”, “storage”, data storage,” and substantially any other information storage component relevant to operation and functionality of a component, refer to any form of memory that can store information and be read by computers or processors or other electronic components. Memory may be volatile memory or nonvolatile memory, or both.

Memory 603 may be used to store the profile database 619 that includes the contact information. The profile database may include a user ID to identify the user, a list of contacts, a type of contact (family, friend, business, etc.), contact information, e.g. way of communicating with each contact such as email, text, voice, voice mail, and action triggering conditions. In addition, the contact information may include priorities for each of the various ways of communicating. In addition, profile may include the threshold emergency level (e.g., red, yellow, await user instruction) for which the MO-CA should contact the contact list without further intervention. The emergency level setting may specify that MO-CA wait for the user to manually instruct the MO-CA to notify the contact list. Note that the profile database may be accessed from one or more remote locations associated with the user equipment found in the emergency location and stored in memory 603 during the emergency.

The processor system also includes one or more external interfaces 615 to couple to a packet network. Thus, interface 615 may provide an interface to communicate with the packet network to communicate with other network nodes. Other communication channels and technologies are within contemplation of the embodiments described herein and may be utilized as needed in various embodiments. The systems and methods described herein can be implemented utilizing various commercially available operating systems or combinations of operating systems.

Thus, aspects of an emergency management system for a cellular network have been described. The description set forth herein is illustrative, and is not intended to limit the scope of the following claims. Variations and modifications of the embodiments disclosed herein may be made based on the description set forth herein, without departing from the scope and spirit of the following claims.

1. A method comprising:
responsive to receiving a notification of an emergency, evaluating one or more aspects of radio access network (RAN) loading; and
diverting an incoming voice call for a user to a voice prompt responsive to the one or more aspects of the RAN loading being above a threshold, the voice prompt informing a caller associated with the incoming voice call to check a social network status of the user.

2. (canceled)

3. (canceled)

4. (canceled)

5. The method as recited in claim 1 further comprising:
taking a preconfigured action on behalf of the user if a preconfigured action triggering condition is met.

6. The method as recited in claim 5 wherein the preconfigured action triggering condition is the emergency being above an emergency threshold condition.

7. The method as recited in claim 1 further comprising:
allowing the user to manually order an emergency call agent to contact one or more stored contacts to deliver a particular message regarding the emergency.

8. The method as recited in claim 1 further comprising:
allowing the user to manually order an emergency call agent to cause an updated status to be indicated on a social network.

9. The method as recited in claim 1 further comprising:
responsive to receiving the notification and the emergency being above an emergency threshold condition, taking action to cause one or more stored contacts to be contacted that the user is impacted by the emergency.

10. The method as recited in claim 9 further comprising:
wherein the action to cause one or more stored contacts to be contacted is taken without instructions from the user.

11. The method as recited in claim 9 further comprising:
wherein the one or more stored contacts are default contacts obtained from user equipment.

12. The method as recited in claim 9 further comprising:
wherein the stored contacts are generated by the user.

13. The method as recited in claim 9 further comprising:
wherein the emergency threshold condition is set by the user.

14. The method as recited in claim 9 further comprising:
contacting the one or more stored contacts according to a form of communication set by the user.

15. The method as recited in claim 14 further comprising:
wherein the form of communication is one of email, voice mail, or text.

16. An emergency mode call agent system comprising:
at least one processor; and
a memory in communication with the processor, the memory comprising computer-executable instructions that, when executed by the at least one processor, cause the at least one processor to perform,
mobile originating emergency call operations including, responsive to receiving an emergency notification, taking action to cause one or more registered contacts to be contacted that a user is impacted by the emergency if the emergency corresponds to an emergency triggering condition set by the user; and
mobile terminating call operations including diverting an incoming voice call to a voice prompt informing a caller associated with the incoming voice call to check a social network status of the user.

17. The emergency mode call agent system as recited in claim 16 wherein the action to cause one or more stored contacts to be contacted is taken without instruction from the user if the emergency triggering condition is met.

18. The emergency mode call agent system as recited in claim 16 wherein the action to cause one or more stored contacts to be contacted is taken responsive to an instruction received from the user after the receiving of the emergency notification.

19. The emergency mode call agent system as recited in claim 16 further comprising computer-executable instructions that, when executed by the at least one processor, cause the at least one processor to perform mobile terminating emergency call operations including determining handling of mobile terminated voice calls according to traffic loading over an air interface in an area affected by the emergency.

20. An emergency mode call agent system comprising:
one or more processors; and
a memory in communication with the one or more processors, the memory comprising computer-executable instructions that, when executed by the one or more processors, cause the one or more processors to perform,
mobile terminating emergency call operations, responsive to receiving a notification of an emergency, the emergency call operations including evaluating one or more aspects of radio access network (RAN) loading and diverting incoming calls from voice format to another communication format responsive to the one or more aspects of the loading being above a threshold;
mobile originating call operations, responsive to receiving the notification of the emergency, the mobile originating call operations including,
causing a first group of registered contacts associated with a user in a user profile to be informed that the user is impacted by the emergency, without intervention by the user, in response to the emergency corresponding to a first emergency level trigger condition stored in the user profile; and
causing a second group of registered contacts associated with the user in the user profile to be contacted that the user is impacted by the emergency, without intervention by the user, in response to the emergency corresponding to a second emergency level trigger condition stored in the user profile.

21. (canceled)
